(19) United States
(12) Patent Application Publication
(10) Pub. No.: US 2025/0029165 A1
(43) Pub. Date: Jan. 23, 2025

(54) GENERATING RECOMMENDATION INFORMATION BASED AT LEAST IN PART ON USER INTENT

(71) Applicant: QUALCOMM Incorporated, San Diego, CA (US)

(72) Inventors: Nikhil JAIN, San Diego, CA (US); Megha DAGA, Fremont, CA (US); Rodney Gracian DSOUZA, San Diego, CA (US)

(21) Appl. No.: 18/394,086

(22) Filed: Dec. 22, 2023

Related U.S. Application Data
(60) Provisional application No. 63/514,074, filed on Jul. 17, 2023.

(51) Int. Cl. G06Q 30/0601

(52) U.S. Cl. CPC G06Q 30/0631; G06Q 30/0625; G06Q 30/0639

(57) ABSTRACT

In some aspects, a device may receive intent information associated with an interaction of a user with a retail entity. The device may obtain a set of recommendation parameters. The device may generate recommendation information associated with the user, the recommendation information being generated based at least in part on the intent information and the set of recommendation parameters. The device may provide the recommendation information for display to the user, the recommendation information including a list of recommended items. Numerous other aspects are described.

### CROSS-REFERENCE TO RELATED APPLICATION

This patent application claims priority to U.S. Provisional Patent Application No. 63/514,074, filed on Jul. 17, 2023, entitled “GENERATING RECOMMENDATION INFORMATION BASED AT LEAST IN PART ON USER INTENT,” and assigned to the assignee hereof. The disclosure of the prior application is considered part of and is incorporated by reference into this patent application.

### FIELD OF THE DISCLOSURE

Aspects of the present disclosure generally relate to generating recommendation information associated with a user and, for example, to generating recommendation information associated with the user based at least in part on information associated with an intent of the user with respect to an interaction.

### BACKGROUND

A large language model (LLM) is a type of artificial intelligence (AI) algorithm that can be configured to utilize deep learning techniques and large data sets to understand, summarize, generate, or predict new information. An LLM is a type of generative AI that can been architected to generate text-based content based on one or more items of input information. A foundation model is an AI model that is trained on broad data such that the model can be applied across a variety of use cases. More particularly, a foundation model may be a model that is trained on broad data (e.g., using self-supervision at scale) and that can be adapted (e.g., fine-tuned) to achieve a wide range of tasks.

### SUMMARY

Some aspects described herein relate to a device. The device may include one or more memories and one or more processors coupled to the one or more memories. The one or more processors may be configured to receive intent information associated with an interaction of a user with a retail entity. The one or more processors may be configured to obtain a set of recommendation parameters. The one or more processors may be configured to generate recommendation information associated with the user, the recommendation information being generated based at least in part on the intent information and the set of recommendation parameters. The one or more processors may be configured to provide the recommendation information for display to the user, the recommendation information including a list of recommended items.

Some aspects described herein relate to a method performed by a device. The method may include receiving intent information associated with an interaction of a user with a retail entity. The method may include obtaining a set of recommendation parameters. The method may include generating recommendation information associated with the user, the recommendation information being generated based at least in part on the intent information and the set of recommendation parameters. The method may include providing the recommendation information for display to the user, the recommendation information including a list of recommended items.

Some aspects described herein relate to a non-transitory computer-readable medium that stores a set of instructions for execution by a device. The set of instructions, when executed by one or more processors of the device, may cause the device to receive intent information associated with an interaction of a user with a retail entity. The set of instructions, when executed by one or more processors of the device, may cause the device to obtain a set of recommendation parameters. The set of instructions, when executed by one or more processors of the device, may cause the device to generate recommendation information associated with the user, the recommendation information being generated based at least in part on the intent information and the set of recommendation parameters. The set of instructions, when executed by one or more processors of the device, may cause the device to provide the recommendation information for display to the user, the recommendation information including a list of recommended items.

Some aspects described herein relate to an apparatus. The apparatus may include means for receiving intent information associated with an interaction of a user with a retail entity. The apparatus may include means for obtaining a set of recommendation parameters. The apparatus may include means for generating recommendation information associated with the user, the recommendation information being generated based at least in part on the intent information and the set of recommendation parameters. The apparatus may include means for providing the recommendation information for display to the user, the recommendation information including a list of recommended items.

Aspects generally include a method, apparatus, system, computer program product, non-transitory computer-readable medium, user device, user equipment, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example environment in which techniques described herein may be used to generate recommendation information based at least in part on user intent, in accordance with the present disclosure.

FIG. 2 is a diagram illustrating example components of a device, in accordance with the present disclosure.

FIG. 3 is a diagram of an example implementation associated with generating recommendation information based at least in part on user intent.

FIG. 4 is a flowchart of an example process associated with generating recommendation information based at least in part on user intent, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

A retail entity (e.g., a brick-and-mortar retail entity) conventionally does not have knowledge of an intent of a user (e.g., a customer) with respect to an interaction between the retail entity and the user. For example, the retail entity may lack knowledge of an intent of a user when the user procures a group of items from the retail entity. Consequently, the interaction between the retail entity and the user may be inefficient from the perspective of the user (e.g., the user may not obtain an item that is best-suited for an intended purpose) or from the perspective of the retail entity (e.g., the user may procure an item that does not maximize revenue or take inventory considerations into account).

Some aspects described herein provide techniques and apparatuses for generation of recommendation information based at least in part on intent of a user with respect to an interaction with a retail entity. In some aspects, a recommendation device may receive intent information associated with an interaction of a user with a retail entity. In some aspects, the recommendation device may obtain a set of recommendation parameters, and may generate recommendation information associated with the user based at least in part on the intent information and the set of recommendation parameters. The recommendation information may include a list of recommended items. The recommendation device may then provide the recommendation information for display to the user.

In some aspects, the techniques and apparatuses described herein enable a retail entity to determine an intent of a user prior to the user interacting with the retail entity (e.g., prior to the user being present at a location of the retail entity), and may allow the retail entity to guide the user toward desirable items and, in some cases, recommend complimentary or substitute items that have a higher value (e.g., to the user or to the retail entity). In this way, efficiency with respect to an interaction between the retail entity and the user may be increased from the perspective of the user (e.g., the user may obtain an item that is best-suited for an intended purpose) or from the perspective of the retail entity (e.g., the user may procure an item that maximizes revenue or takes inventory considerations into account). Additional details and aspects are provided below.

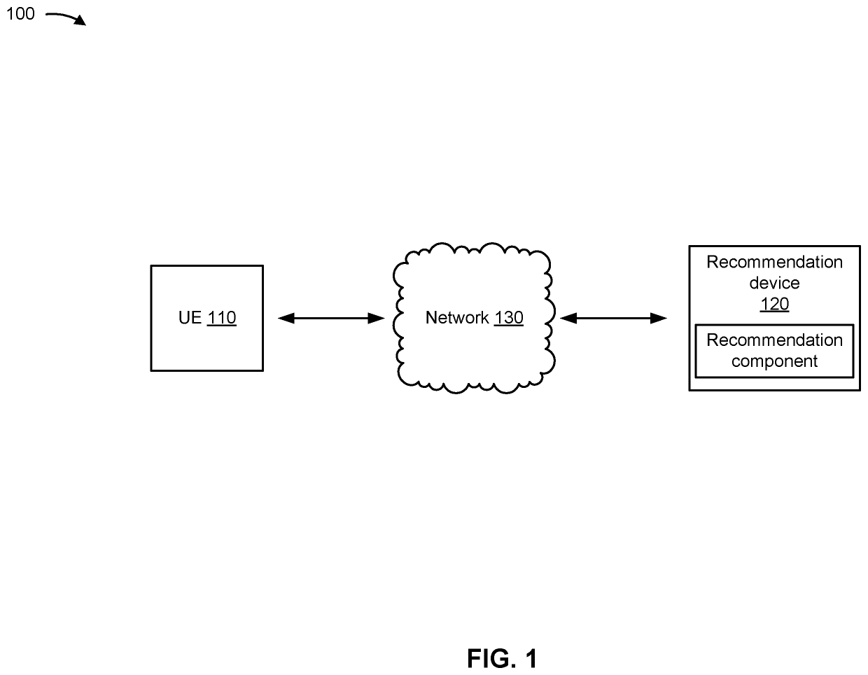

FIG. 1 is a diagram illustrating an example environment 100 in which techniques described herein may be used to generate recommendation information based at least in part on user intent, in accordance with the present disclosure. As shown in FIG. 1, the environment 100 may include a user equipment (UE) 110, a recommendation device 120, and a network 130. Devices of the environment 100 may interconnect via wired connections, wireless connections, or a combination of wired and wireless connections.

The UE 110 includes one or more devices capable of performing operations associated with generating recommendation information based at least in part on user intent. In some aspects, the UE 110 may include a wired and/or wireless communication and/or computing device, such as a UE, a mobile phone (e.g., a smart phone, a radiotelephone, and/or the like), a laptop computer, a tablet computer, a handheld computer, a desktop computer, a gaming device, a wearable communication device (e.g., a smart wristwatch, a pair of smart eyeglasses, and/or the like), or the like.

Similar to the UE 110, the recommendation device 120 includes one or more devices capable of receiving, generating, storing, processing, and/or providing information related to generating recommendation information based at least in part on user intent, as described herein. The recommendation device 120 may include a communication device and/or a computing device. For example, the recommendation device 120 may include a server, such as an application server, a client server, a web server, a database server, a host server, a proxy server, a virtual server (e.g., executing on computing hardware), or a server in a cloud computing system. In some aspects, the recommendation device 120 may include computing hardware used in a cloud computing environment. As further shown, the recommendation device 120 may in some aspects include a recommendation component. In some aspects, the recommendation component can generate recommendation information associated with a user based at least in part on intent information and a set of recommendation parameters, and provide the recommendation information for display to the user (e.g., via the UE 110).

The network 130 includes one or more wired and/or wireless networks. For example, the network 130 may include a cellular network (e.g., a Long-Term Evolution (LTE) network, a code division multiple access (CDMA) network, a 3G network, a 4G network, a 5G network, another type of next generation network, and/or the like), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of the environment 100 may perform one or more functions described as being performed by another set of devices of the environment 100.

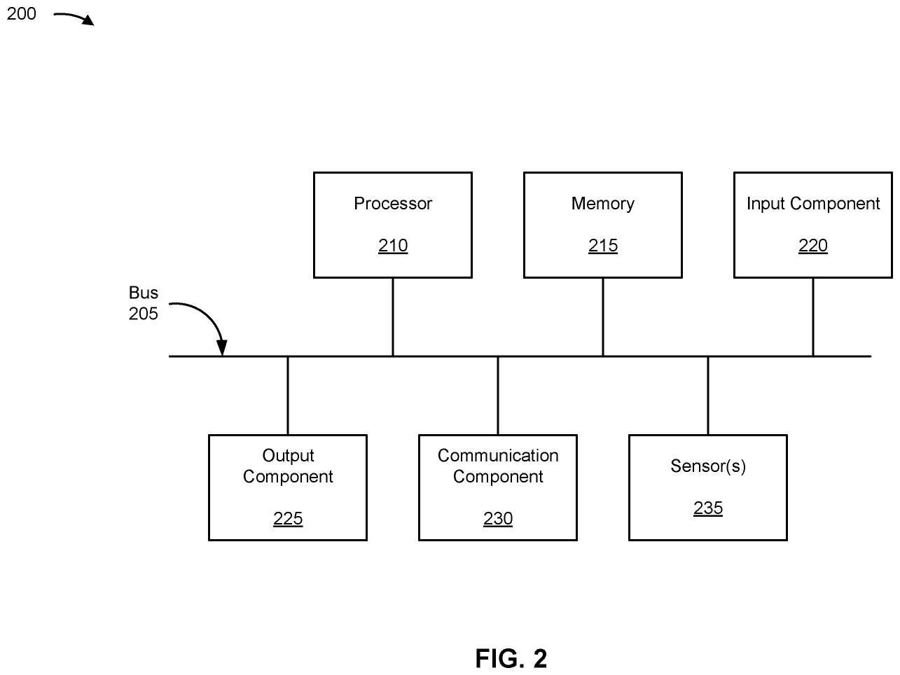

FIG. 2 is a diagram illustrating example components of a device 200, in accordance with the present disclosure. The device 200 may correspond to a UE 110 and/or a recommendation device 120. In some aspects, the UE 110 and/or the recommendation device 120 may include one or more devices 200 and/or one or more components of the device 200. As shown in FIG. 2, the device 200 may include a bus 205, a processor 210, a memory 215, an input component 220, an output component 225, a communication component 230, and/or one or more sensors 235.

The bus 205 may include one or more components that enable wired and/or wireless communication among the components of the device 200. The bus 205 may couple together two or more components of FIG. 2, such as via operative coupling, communicative coupling, electronic coupling, and/or electric coupling. For example, the bus 205 may include an electrical connection (e.g., a wire, a trace, and/or a lead) and/or a wireless bus. The processor 210 may include a central processing unit, a graphics processing unit, a microprocessor, a controller, a microcontroller, a digital signal processor, a field-programmable gate array, an application-specific integrated circuit, and/or another type of processing component. The processor 210 may be implemented in hardware, firmware, or a combination of hardware and software. In some aspects, the processor 210 may include one or more processors capable of being programmed to perform one or more operations or processes described elsewhere herein.

The memory 215 may include volatile and/or nonvolatile memory. For example, the memory 215 may include random access memory (RAM), read only memory (ROM), a hard disk drive, and/or another type of memory (e.g., a flash memory, a magnetic memory, and/or an optical memory). The memory 215 may include internal memory (e.g., RAM, ROM, or a hard disk drive) and/or removable memory (e.g., removable via a universal serial bus connection). The memory 215 may be a non-transitory computer-readable medium. The memory 215 may store information, one or more instructions, and/or software (e.g., one or more software applications) related to the operation of the device 200. In some aspects, the memory 215 may include one or more memories that are coupled (e.g., communicatively coupled) to one or more processors (e.g., processor 210), such as via the bus 205. Communicative coupling between a processor 210 and a memory 215 may enable the processor 210 to read and/or process information stored in the memory 215 and/or to store information in the memory 215.

The input component 220 may enable the device 200 to receive input, such as user input and/or sensed input. For example, the input component 220 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 225 may enable the device 200 to provide output, such as via a display, a speaker, and/or a light-emitting diode. The communication component 230 may enable the device 200 to communicate with other devices via a wired connection and/or a wireless connection. For example, the communication component 230 may include a receiver, a transmitter, a transceiver, a modem, a network interface card, and/or an antenna.

The one or more sensors 235 include one or more wired or wireless devices capable of receiving, generating, storing, transmitting, processing, detecting, and/or providing sensor information based at least in part on which recommendation information can be generated, as described elsewhere herein. For example, the one or more sensors 235 may include an angle sensor, a Hall-effect sensor, a magnetic sensor, a proximity sensor, a motion sensor, an accelerometer, a gyroscope, a light sensor, a noise sensor, a pressure sensor, an ultrasonic sensor, a positioning sensor, a capacitive sensor, a timing device, an infrared sensor, an active sensor (e.g., a sensor that requires an external power signal), a passive sensor (e.g., a sensor that does not require an external power signal), a biological or biometric sensor, a smoke sensor, a gas sensor, a chemical sensor, an alcohol sensor, a temperature sensor, a moisture sensor, a humidity sensor, a radioactive sensor, an electromagnetic sensor, an analog sensor, and/or a digital sensor, among other examples. The one or more sensors 235 may sense or detect sensor information (e.g., a condition, a state, or the like) and transmit, using a wired or wireless communication interface, an indication of the sensor information to other components of the device 200 and/or other devices.

The device 200 may perform one or more operations or processes described herein. For example, a non-transitory computer-readable medium (e.g., memory 215) may store a set of instructions (e.g., one or more instructions or code) for execution by the processor 210. The processor 210 may execute the set of instructions to perform one or more operations or processes described herein. In some aspects, execution of the set of instructions, by one or more processors 210, causes the one or more processors 210 and/or the device 200 to perform one or more operations or processes described herein. In some aspects, hardwired circuitry may be used instead of or in combination with the instructions to perform one or more operations or processes described herein. Additionally, or alternatively, the processor 210 may be configured to perform one or more operations or processes described herein. Thus, aspects described herein are not limited to any specific combination of hardware circuitry and software.

In some aspects, device 200 may include means for receiving intent information associated with an interaction of a user with a retail entity; means for obtaining a set of recommendation parameters; means for generating recommendation information associated with the user, the recommendation information being generated based at least in part on the intent information and the set of recommendation parameters; and/or means for providing the recommendation information for display to the user, the recommendation information including a list of recommended items. In some aspects, the means for device 200 to perform processes and/or operations described herein may include one or more components of device 200 described in connection with FIG. 2, such as bus 205, processor 210, memory 215, input component 220, output component 225, communication component 230, and/or one or more sensors 235.

The number and arrangement of components shown in FIG. 2 are provided as an example. The device 200 may include additional components, fewer components, different components, or differently arranged components than those shown in FIG. 2. Additionally, or alternatively, a set of components (e.g., one or more components) of the device 200 may perform one or more functions described as being performed by another set of components of the device 200.

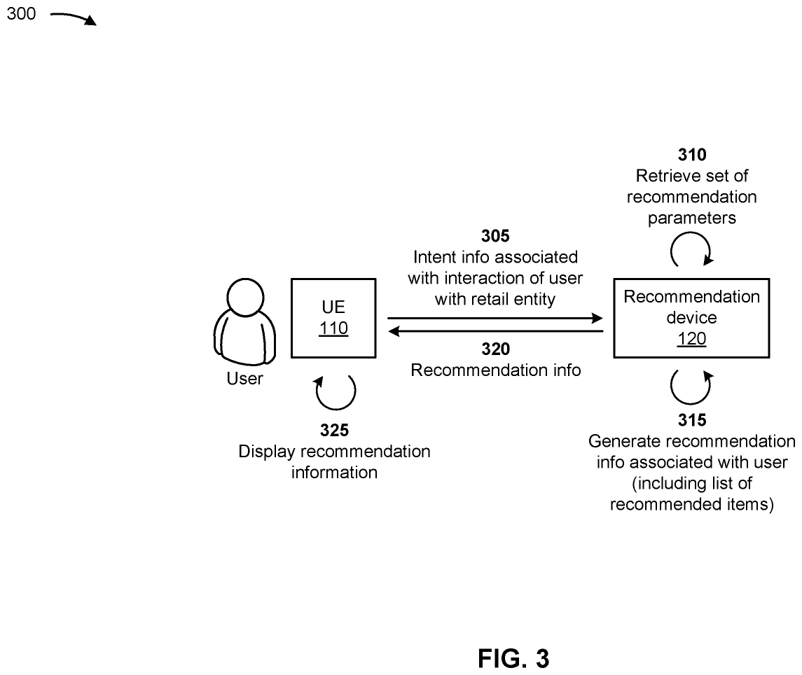

FIG. 3 is a diagram of an example implementation 300 associated with generating recommendation information based at least in part on user intent. As shown in FIG. 3, the example implementation 300 includes a UE 110 and a recommendation device 120. These devices are described in more detail above in connection with FIG. 1 and FIG. 2.

As shown at reference 305, the recommendation device 120 may receive intent information associated with an interaction of a user with a retail entity. The intent information includes information indicating an intent of the user with respect to an interaction with the retail entity. For example, the intent information may include information indicating a reason that the user (e.g., a potential customer of the retail entity) is going to visit the retail entity (e.g., a brick-and-mortar retail store). In one particular example, the intent information may include information indicating that the user is going to visit the retail entity in order to procure items to make an Italian meal for a particular number of people. In another particular example, the intent information may include information indicating that the user is going to visit the retail entity in order to procure items to build an outdoor dog house.

In some aspects, the recommendation device 120 may receive the intent information from the UE 110. For example, the user may provide (e.g., via an application associated with the retail entity) user input to the UE 110, with the user input indicating the intent of the user with respect to visiting the retail entity. Here, the UE 110 may provide the intent information to the recommendation device 120. In some aspects, the recommendation device 120 may receive the intent information prior to the user visiting the retail entity (e.g., before the user arrives at the retail entity). Additionally, or alternatively, the recommendation device 120 may receive the intent information while the user is present at the retail entity.

In some aspects, the recommendation device 120 may receive target information associated with the interaction (e.g., in addition to the intent information). The target information may include a list of target items indicated by the user (e.g., a list of items that the user has indicated a desire to procure at the retail entity). In some aspects, the recommendation device 120 may generate the recommendation information based at least in part on the target information, as described below.

As shown at reference 310, the recommendation device 120 may obtain a set of recommendation parameters. A recommendation parameter is a parameter based at least in part on which recommendation information is to be generated by the recommendation device 120. That is, a recommendation parameter is a parameter to be taken into account by the recommendation device 120 when generating the recommendation information associated with the user.

In some aspects, the set of recommendation parameters may include constraint information. In some aspects, the constraint information may be associated with the user. Additionally, or alternatively, the constraint information may be associated with the retail entity. Additionally, or alternatively, the constraint information may be associated with a device, such as the UE 110 or the recommendation device 120. The constraint information may include information that indicates a constraint or a restriction based at least in part on which the recommendation information is to be generated. For example, constraint information associated with a user may include a dietary constraint (e.g., a type of consumable item that is not to be included in the recommendation information), a cost constraint (e.g., a maximum cost associated with a given type of item, or a maximum total cost for all items), a brand constraint (e.g., a brand of item that is not to be included in the recommendation information), or a size constraint (e.g., a maximum amount or size for a given item), among other examples. As another example, constraint information associated with a retail entity may include an inventory constraint (e.g., an item that is not to be included in the recommendation information due to low inventory, an item that is to be included in the recommendation information due to high inventory), a brand constraint (e.g., a brand of item that is to be recommended due to ongoing sale associated with that brand of the item), a seasonal constraint (e.g., a particular type of item may be included in the recommendation information only near Christmas time), or a location-based constraint (e.g., a particular item may be recommended based on a location of the retail entity), among other examples. As another example, constraint information associated with a UE 110 may include a household constraint (e.g., a UE 110 associated with a household profile may have the same set of preferences as other UEs 110 associated with the household profile when, for example, a user of the UE 110 has not provided any preferences), a device type (e.g., recommendation information to be provided to a comparatively more expensive UE 110 may be slated towards higher-end items), or a device configuration or setting (e.g., a child's UE 110 or a UE 110 operating an operating system OS configured to support a child may be restricted from receiving recommendation information that includes alcohol-related products), among other examples.

Additionally, or alternatively, the set of recommendation parameters may include preference information associated with the user. The preference information associated with the user may include information that indicates a preference associated with one or more items. The preference may be related to, for example, a brand of an item, a size of an item, or a cost of an item, among other examples.

Additionally, or alternatively, the set of recommendation parameters may include positive bias information associated with the retail entity. The positive bias information associated with the retail entity may include information that indicates a positive bias based at least in part on which the recommendation information is to be generated, with the positive bias being provided by, indicated by, or otherwise associated with the retail entity. For example, the positive bias information associated with the retail entity may include information that indicates a prioritization among items in a group of items, with the prioritization being indicated by the retail entity. In some aspects, the prioritization indicated by the positive bias information can be based at least in part on revenue information associated with the group of items (e.g., such that items that provide higher revenue have higher priority), margin information associated with the group of items (e.g., such that items with higher profit margin have higher priority), or inventory information associated with the group of items (e.g., such that items for which there is more available inventory have higher priority), among other examples.

Additionally, or alternatively, the set of recommendation parameters may include negative bias information associated with the retail entity. The negative bias information associated with the retail entity may include information that indicates a negative bias based at least in part on which the recommendation information is to be generated, with the negative bias being provided by, indicated by, or otherwise associated with the retail entity. For example, the negative bias information associated with the retail entity may include information that indicates a prioritization among items in a group of items, with the prioritization being indicated by the retail entity. In some aspects, the prioritization indicated by the negative bias information can be based at least in part on revenue information associated with the group of items (e.g., such that items that provide lower revenue have lower priority), margin information associated with the group of items (e.g., such that items with lower profit margin have lower priority), or inventory information associated with the group of items (e.g., such that items for which there is less available inventory have lower priority), among other examples.

Additionally, or alternatively, the set of recommendation parameters may include inventory information associated with the retail entity. The inventory information associated with the retail entity may include, for example, information indicating an amount of available inventory for a given item.

In some aspects, the recommendation device 120 may obtain one or more recommendation parameters from the UE 110. For example, the user of the UE 110 may provide user input indicating constraint information associated with the user or preference information associated with the user. The UE 110 may then provide such information to the recommendation device 120 (e.g., along with the intent information associated with the interaction), and the recommendation device 120 may store such information in the form of one or more recommendation parameters. In some aspects, the recommendation device 120 may store the one or more recommendation parameters such that the one or more recommendation parameters are associated with the user (e.g., the one or more recommendation parameters may be associated with an identifier of the user or an identifier of the UE 110) in order to enable the recommendation device 120 to retrieve the one or more recommendation parameters from storage (at a later time) based at least in part on the association with the user.

In some aspects, the recommendation device 120 may obtain one or more recommendation parameters from the retail entity. For example, a device associated with the retail entity may provide (e.g., automatically or based on user input) positive bias information, negative bias information, or inventory information associated with the retail entity. The recommendation device 120 may store such information in the form of one or more recommendation parameters. In some aspects, the recommendation device 120 may store the one or more recommendation parameters such that the one or more recommendation parameters are associated with the retail entity (e.g., the one or more recommendation parameters may be associated with an identifier of a particular location of the retail entity) in order to enable the recommendation device 120 to retrieve the one or more recommendation parameters from storage (at a later time) based at least in part on the association with the retail entity.

As shown at reference 315, the recommendation device 120 may generate recommendation information associated with the user. In some aspects, the recommendation device 120 generates the recommendation information based at least in part on the intent information and the set of recommendation parameters. In some aspects, the recommendation information includes a list of recommended items (e.g., a list of items that are recommended for purchase by the user).

In some aspects, the recommendation device 120 may have access to one or more models that can be used to generate the recommendation information. For example, the one or more models can be configured to generate recommendation information (e.g., a list of recommended items) based at least in part on the intent information associated with the user and the set of recommendation parameters. In some aspects, the one or more models may include, for example, an LLM, a foundation model, machine learning (ML) model, a generative AI model, or another type of model. As described above, the set of recommendation parameters may include one or more recommendation parameters obtained based at least in part on information associated with the user, such as constraint information (e.g., a dietary restriction, a cost restriction, a brand restriction, a size restriction, or the like) or preference information associated with the user. Further, as described above, the set of recommendation parameters may include one or more recommendation parameters obtained based at least in part on information associated with the retail entity, such as positive bias information associated with the retail entity (e.g., a prioritization of items based on having a higher revenue, a higher margin, a higher available inventory, or the like), negative bias information associated with the retail entity (e.g., a prioritization of items based on having a lower revenue, a lower margin, a lower available inventory, or the like), inventory information (e.g., information indicating an amount of inventory for a given item), or the like. In some aspects, the intent information and the set of recommendation parameters can be provided in a prompt or as an embedding concatenation to the one or more models, and the one or more models can be biased to output recommendation information that takes the set of recommendation parameters into account.

In some aspects, an output of the one or more models includes the recommendation information. For example, the output of the one or more models may include a list of recommended items, with the list of recommended items being generated by the one or more models based at least in part on the intent information, the set of recommendation parameters, or one or more other items of information (e.g., target information provided by the user). In some aspects, the recommendation information includes cost information associated with the list of recommended items. For example, the recommendation information may include information that indicates a cost for each item in the list of recommended items, or information that indicates a total cost of all of the items in the list of recommended items. Additionally, or alternatively, the recommendation information may include size information associated with the list of recommended items. For example, the recommendation information may include information that indicates a size for each item in the list of recommended items (e.g., a weight, a volume, a mass, or the like). Additionally, or alternatively, the recommendation information may include reasoning information associated with an item included in the list of recommended items. The reasoning information may include information indicating a reason that a given item was included in the list of recommended items. In one particular example, the intent information may indicate that the user is going to visit the retail entity in order to procure items to build an outdoor dog house. Here, the recommendation information may include a list of recommended items comprising stainless steel nails and may further include reasoning information indicating that the stainless steel nails were included in the list (rather than iron nails) because of the intended outdoor use of the item. In another particular example, the intent information may indicate that the user is going to visit the retail entity in order to procure items to prepare an Italian meal for a particular number of people. Further, the set of recommendation parameters may include a parameter indicating that consumable items should be gluten-free. Here, the recommendation information may include a list of recommended items comprising gluten-free pasta and may further include reasoning information indicating that the gluten-free pasta was included in the list (rather than regular pasta) because of the intended use of the item and the dietary constraint.

In some aspects, the list of recommended items may include one or more supplemental items. The one or more supplemental items may include one or more items identified by the recommendation device 120 (e.g., by a foundation model accessible by the recommendation device 120) to supplement the items identified based at least in part on the intent information. In one example, the intent information may indicate that the user is going to visit the retail entity in order to procure items to prepare an Italian meal for a particular number of people. Here, the recommendation information may include a list of recommended items comprising a particular bottle of wine and may further include reasoning information indicating that the bottle of wine was included in the list as a supplemental item.

In some aspects, the recommendation device 120 may generate the recommendation information based at least in part on user input. For example, the recommendation device 120 may generate recommendation information including a list of items. Here, the recommendation device 120 may determine a list of item types for a given item on the list of recommended items (e.g., a list of available brands for a given item on the list of recommended items). The recommendation device 120 may then provide, for display to the user via the UE 110, the list of item types associated with the item. The user may select, via user input, an item type from the list of item types, and the UE 110 may provide information indicating the selected item type to the recommendation device 120. The recommendation device 120 may then identify the selected item type as a recommended item type, and may include the item and an indication of the recommended item type (e.g., the selected brand of the item) in the list of recommended items. In this way, the recommendation device 120 may (e.g., dynamically, as the user traverses the retail entity) provide a list of item types for a particular item, and the user can select an item type such that the recommendation device 120 can add to or update the recommendation information to include the item of the selected item type.

As shown at reference 320, the recommendation device 120 may provide, and the UE 110 may receive, the recommendation information for display to the user. For example, the recommendation device 120 may provide recommendation information to the UE 110 such that the UE 110 can display the recommendation information (e.g., the list of recommended items) for viewing by the user.

In some aspects, the recommendation device 120 may provide the recommendation information to the UE 110 based at least in part on an indication from the UE 110 (e.g., when the user requests the recommendation information via an application configured on the UE 110). Additionally, or alternatively, the recommendation device 120 may provide the recommendation information automatically (e.g., without an indication from the user).

Additionally, or alternatively, the recommendation device 120 may provide the recommendation information based at least in part on a location of the UE 110. For example, the recommendation device 120 may obtain (e.g., from the UE 110) information indicating a location of the UE 110. Further, the recommendation device 120 may have access to information that indicates a location of the retail entity that the user is to visit. In one example, the recommendation device 120 may provide the recommendation information to the UE 110 when the location of the UE 110 matches a location of the retail entity (e.g., when the user arrives at the retail entity). As another example, the recommendation device 120 may provide the recommendation information to the UE 110 when the location of the UE 110 is within a threshold distance of the location of the retail entity (e.g., when the user is within 0.5 kilometers of the retail entity).

As shown at reference 325, the UE 110 may display the recommendation information (e.g., the list of recommended items) to the user. That is, the UE 110 may provide the recommendation information for viewing by the user (e.g., so that the user can use the list in order to procure the items while visiting the retail entity).

In some aspects, the recommendation device 120 may provide a path recommendation associated with the retail entity. The path recommendation may include information that indicates a physical pathway through the retail entity. In some aspects, the recommendation device 120 may obtain location information associated with the list of recommended items. The location information may include information (e.g., an aisle number, a bin number, a set of coordinates, or the like) that identifies a location of each item included in the list of recommended items within the retail entity. The recommendation device 120 may then generate the path recommendation based at least in part on the location information. In some aspects, the recommendation device 120 may be configured to generate the path recommendation so as to provide a most efficient (e.g., shortest, fastest, or the like) path for the user to traverse in order to procure the items on the list of recommended items. Additionally, or alternatively, the recommendation device 120 may be configured to generate the path recommendation so as to provide a retail-entity-desired path for the user to traverse in order to procure the items on the list of recommended items. The retail-entity-desired path may, for example, be a path that causes the user to be near one or more locations within the retail entity that are desirable to the retail entity (e.g., a coffee shop, a particular product display, or the like). In some aspects, the recommendation device 120 may provide the path recommendation to the UE 110 so that the path recommendation can be displayed to the user. In some aspects, the UE 110 may display the path recommendation such that the user is navigated along the path associated with the path recommendation in real-time or near real-time (e.g., as the traverses the retail entity).

In some aspects, when displayed by the UE 110, the list of recommended items may be sorted based at least in part on location information associated with the UE 110. For example, the recommendation device 120 may have access to information that identifies a location of each item in the list of recommended items. Here, as the user moves through the retail entity, the recommendation device 120 may obtain information that identifies a location of the user. The recommendation device 120 may then update the recommendation information such that the list of recommended items is sorted, for example, such that items in the list that are nearer to the location of the user are higher on the list than items that are further from the location of the user. In some aspects, the recommendation device 120 may update the recommendation information in real-time or near real-time (e.g., such that the list of recommended items is updated based at least in part on the user-location-based sorting of items as the user moves throughout the retail entity).

In this way, a retail entity may utilize the recommendation device 120 to determine an intent of the user with respect to an interaction with the retail entity (e.g., prior to the user being present at a location of the retail entity), and to guide the user toward desirable items and, in some cases, recommend complementary or substitute items that have a higher value (e.g., to the user or to the retail entity). For example, the recommendation device 120 may recommend a type of a given item (e.g., a brand) based at least in part on a set of recommendation parameters or based at least in part on user input. As one particular example, the recommendation device 120 may recommend of an item type A for a particular item (e.g., an item on a target item list, an item on a recommended item list, or the like) rather than item type B of the particular item based at least in part on an intent of the user associated with the item. As another particular example, the recommendation device 120 may recommend ingredient type A over ingredient type B when the intent information indicates that the user is preparing gluten-free pasta. As another particular example, the recommendation device 120 may recommend a nail type A (e.g., stainless steel) over nail type B (e.g., iron) when the intent information indicates that a user is constructing an outdoor dog house. As another particular example, the recommendation device 120 may recommend an ingredient type C based at least in part on ingredient type C having a higher profit margin and a taste that aligns with a user preference. Further, efficiency with respect to an interaction between the retail entity and the user may be increased from the perspective of the user (e.g., the user may obtain an item that is best-suited for an intended purpose) or from the perspective of the retail entity (e.g., the user may procure an item that maximizes revenue or takes inventory considerations into account). Additionally, the retail entity may utilize the recommendation device 120 to adapt target information provided by the user (e.g., a shopping list provided by the user) so as to benefit the retail entity or the user with respect to the interaction with the retail entity.

As indicated above, FIG. 3 is provided as an example. Other examples may differ from what is described with regard to FIG. 3. The number and arrangement of devices shown in FIG. 3 are provided as an example. In practice, there may be additional devices, fewer devices, different devices, or differently arranged devices than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) shown in FIG. 3 may perform one or more functions described as being performed by another set of devices shown in FIG. 3.

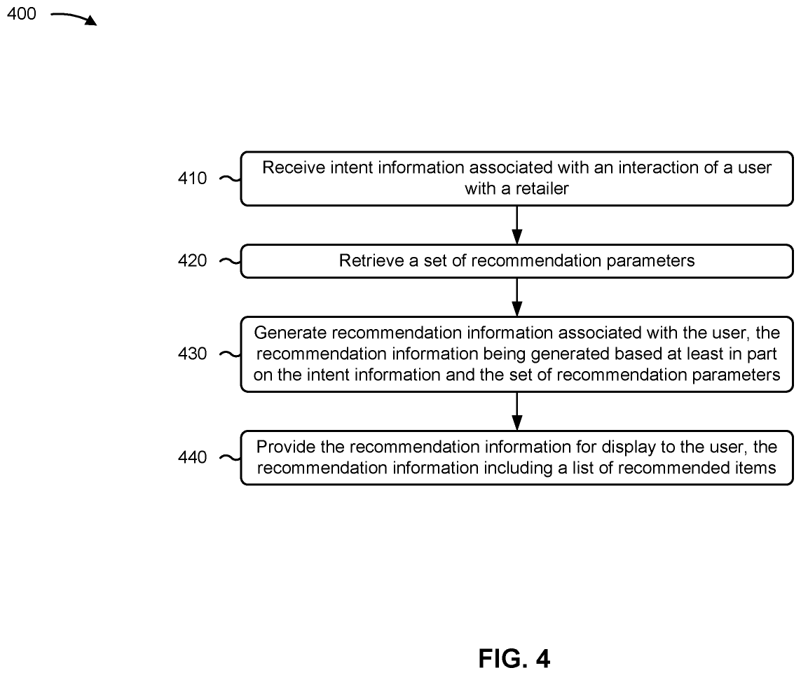

FIG. 4 is a flowchart of an example process 400 associated with generating recommendation information based at least in part on user intent, in accordance with the present disclosure. In some aspects, one or more process blocks of FIG. 4 are performed by a device (e.g., recommendation device 120). In some aspects, one or more process blocks of FIG. 4 are performed by another device or a group of devices separate from or including the device, such as a UE (e.g., UE 110). Additionally, or alternatively, one or more process blocks of FIG. 4 may be performed by one or more components of device 200, such as processor 210, memory 215, input component 220, output component 225, communication component 230, and/or a sensor 235.

As shown in FIG. 4, process 400 may include receiving intent information associated with an interaction of a user with a retail entity (block 410). For example, the device may receive intent information associated with an interaction of a user with a retail entity, as described above.

As further shown in FIG. 4, process 400 may include obtaining a set of recommendation parameters (block 420). For example, the device may obtain a set of recommendation parameters, as described above.

As further shown in FIG. 4, process 400 may include generating recommendation information associated with the user, the recommendation information being generated based at least in part on the intent information and the set of recommendation parameters (block 430). For example, the device may generate recommendation information associated with the user, the recommendation information being generated based at least in part on the intent information and the set of recommendation parameters, as described above.

As further shown in FIG. 4, process 400 may include providing the recommendation information for display to the user, the recommendation information including a list of recommended items (block 440). For example, the device may provide the recommendation information for display to the user, the recommendation information including a list of recommended items, as described above.

Process 400 may include additional aspects, such as any single aspect or any combination of aspects described below and/or in connection with one or more other processes described elsewhere herein.

In a first aspect, the set of recommendation parameters includes constraint information.

In a second aspect, alone or in combination with the first aspect, the set of recommendation parameters includes positive bias information associated with the retail entity.

In a third aspect, alone or in combination with one or more of the first and second aspects, the positive bias information indicates a prioritization that is based at least in part on at least one of revenue information associated with a group of items, margin information associated with the group of items, or inventory information associated with the group of items.

In a fourth aspect, alone or in combination with one or more of the first through third aspects, the set of recommendation parameters includes negative bias information associated with the retail entity.

In a fifth aspect, alone or in combination with one or more of the first through fourth aspects, the negative bias information indicates a prioritization that is based at least in part on at least one of revenue information associated with a group of items, margin information associated with the group of items, or inventory information associated with the group of items.

In a sixth aspect, alone or in combination with one or more of the first through fifth aspects, the set of recommendation parameters includes inventory information associated with the retail entity.

In a seventh aspect, alone or in combination with one or more of the first through sixth aspects, the set of recommendation parameters includes preference information associated with the user.

In an eighth aspect, alone or in combination with one or more of the first through seventh aspects, the recommendation information includes cost information associated with the list of recommended items.

In a ninth aspect, alone or in combination with one or more of the first through eighth aspects, the recommendation information includes reasoning information associated with an item included in the list of recommended items.

In a tenth aspect, alone or in combination with one or more of the first through ninth aspects, process 400 includes receiving target information associated with the interaction, the target information including a list of target items, wherein the recommendation information associated with the user is generated further based at least in part on the target information.

In an eleventh aspect, alone or in combination with one or more of the first through tenth aspects, process 400 includes determining a list of item types associated with an item, providing, for display to the user, the list of item types associated with the item, and identifying, based at least in part on user input, a recommended item type from the list of item types, wherein the list of recommended items includes the item and an indication of the recommended item type associated with the item.

In a twelfth aspect, alone or in combination with one or more of the first through eleventh aspects, process 400 includes obtaining location information associated with the list of recommended items, generating a path recommendation associated with the retail entity based at least in part on the location information, and providing the path recommendation for display to the user.

In a thirteenth aspect, alone or in combination with one or more of the first through twelfth aspects, the list of recommended items is sorted based at least in part on location information associated with the user.

Although FIG. 4 shows example blocks of process 400, in some aspects, process 400 includes additional blocks, fewer blocks, different blocks, or differently arranged blocks than those depicted in FIG. 4. Additionally, or alternatively, two or more of the blocks of process 400 may be performed in parallel.

The following provides an overview of some Aspects of the present disclosure:

Aspect 1: A method performed by a device, the method comprising: receiving intent information associated with an interaction of a user with a retail entity; obtaining a set of recommendation parameters; generating recommendation information associated with the user, the recommendation information being generated based at least in part on the intent information and the set of recommendation parameters; and providing the recommendation information for display to the user, the recommendation information including a list of recommended items.

Aspect 2: The method of Aspect 1, wherein the set of recommendation parameters includes constraint information.

Aspect 3: The method of any of Aspects 1-2, wherein the set of recommendation parameters includes positive bias information associated with the retail entity.

Aspect 4: The method of Aspect 3, wherein the positive bias information indicates a prioritization that is based at least in part on at least one of revenue information associated with a group of items, margin information associated with the group of items, or inventory information associated with the group of items.

Aspect 5: The method of any of Aspects 1-4, wherein the set of recommendation parameters includes negative bias information associated with the retail entity.

Aspect 6: The method of Aspect 5, wherein the negative bias information indicates a prioritization that is based at least in part on at least one of revenue information associated with a group of items, margin information associated with the group of items, or inventory information associated with the group of items.

Aspect 7: The method of any of Aspects 1-6, wherein the set of recommendation parameters includes inventory information associated with the retail entity.

Aspect 8: The method of any of Aspects 1-7, wherein the set of recommendation parameters includes preference information associated with the user.

Aspect 9: The method of any of Aspects 1-8, wherein the recommendation information includes cost information associated with the list of recommended items.

Aspect 10: The method of any of Aspects 1-9, wherein the recommendation information includes reasoning information associated with an item included in the list of recommended items.

Aspect 11: The method of any of Aspects 1-10, further comprising receiving target information associated with the interaction, the target information including a list of target items, wherein the recommendation information associated with the user is generated further based at least in part on the target information.

Aspect 12: The method of any of Aspects 1-11, further comprising: determining a list of item types associated with an item, providing, for display to the user, the list of item types associated with the item, and identifying, based at least in part on user input, a recommended item type from the list of item types, wherein the list of recommended items includes the item and an indication of the recommended item type associated with the item.

Aspect 13: The method of any of Aspects 1-12, further comprising: obtaining location information associated with the list of recommended items, generating a path recommendation associated with the retail entity based at least in part on the location information, and providing the path recommendation for display to the user.

Aspect 14: The method of any of Aspects 1-13, wherein the list of recommended items is sorted based at least in part on location information associated with the user.

Aspect 15: An apparatus at a device, comprising a processor; memory coupled with the processor; and instructions stored in the memory and executable by the processor to cause the apparatus to perform the method of one or more of Aspects 1-14.

Aspect 16: A device, comprising a memory and one or more processors coupled to the memory, the one or more processors configured to perform the method of one or more of Aspects 1-14.

Aspect 17: An apparatus, comprising at least one means for performing the method of one or more of Aspects 1-14.

Aspect 18: A non-transitory computer-readable medium storing code, the code comprising instructions executable by a processor to perform the method of one or more of Aspects 1-14.

Aspect 19: A non-transitory computer-readable medium storing a set of instructions, the set of instructions comprising one or more instructions that, when executed by one or more processors of a device, cause the device to perform the method of one or more of Aspects 1-14.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A device, comprising:
one or more memories; and
one or more processors, coupled to the one or more memories, configured to:
receive intent information associated with an interaction of a user with a retail entity;
obtain a set of recommendation parameters;
generate recommendation information associated with the user, the recommendation information being generated based at least in part on the intent information and the set of recommendation parameters; and
provide the recommendation information for display to the user, the recommendation information including a list of recommended items.

2. The device of claim 1, wherein the set of recommendation parameters includes constraint information.

3. The device of claim 1, wherein the set of recommendation parameters includes positive bias information associated with the retail entity.

4. The device of claim 3, wherein the positive bias information indicates a prioritization that is based at least in part on at least one of revenue information associated with a group of items, margin information associated with the group of items, or inventory information associated with the group of items.

5. The device of claim 1, wherein the set of recommendation parameters includes negative bias information associated with the retail entity.

6. The device of claim 5, wherein the negative bias information indicates a prioritization that is based at least in part on at least one of revenue information associated with a group of items, margin information associated with the group of items, or inventory information associated with the group of items.

7. The device of claim 1, wherein the set of recommendation parameters includes inventory information associated with the retail entity.

8. The device of claim 1, wherein the set of recommendation parameters includes preference information associated with the user.

9. The device of claim 1, wherein the recommendation information includes cost information associated with the list of recommended items.

10. The device of claim 1, wherein the recommendation information includes reasoning information associated with an item included in the list of recommended items.

11. The device of claim 1, wherein the one or more processors are further configured to receive target information associated with the interaction, the target information including a list of target items, wherein the recommendation information associated with the user is generated further based at least in part on the target information.

12. The device of claim 1, wherein the one or more processors are further configured to:
determine a list of item types associated with an item,
provide, for display to the user, the list of item types associated with the item, and
identify, based at least in part on user input, a recommended item type from the list of item types, wherein the list of recommended items includes the item and an indication of the recommended item type associated with the item.

13. The device of claim 1, wherein the one or more processors are further configured to:
obtain location information associated with the list of recommended items,
generate a path recommendation associated with the retail entity based at least in part on the location information, and
provide the path recommendation for display to the user.

14. The device of claim 1, wherein the list of recommended items is sorted based at least in part on location information associated with the user.

15. A method performed by a device, the method comprising:
receiving intent information associated with an interaction of a user with a retail entity;
obtaining a set of recommendation parameters;
generating recommendation information associated with the user, the recommendation information being generated based at least in part on the intent information and the set of recommendation parameters; and
providing the recommendation information for display to the user, the recommendation information including a list of recommended items.

16. The method of claim 15, wherein the set of recommendation parameters includes constraint information.

17. The method of claim 15, wherein the set of recommendation parameters includes positive bias information associated with the retail entity.

18. The method of claim 17, wherein the positive bias information indicates a prioritization that is based at least in part on at least one of revenue information associated with a group of items, margin information associated with the group of items, or inventory information associated with the group of items.

19. The method of claim 15, wherein the set of recommendation parameters includes negative bias information associated with the retail entity.

20. The method of claim 19, wherein the negative bias information indicates a prioritization that is based at least in part on at least one of revenue information associated with a group of items, margin information associated with the group of items, or inventory information associated with the group of items.

21. The method of claim 15, wherein the set of recommendation parameters includes inventory information associated with the retail entity.

22. The method of claim 15, wherein the set of recommendation parameters includes preference information associated with the user.

23. The method of claim 15, wherein the recommendation information includes cost information associated with the list of recommended items.

24. The method of claim 15, wherein the recommendation information includes reasoning information associated with an item included in the list of recommended items.

25. The method of claim 15, further comprising receiving target information associated with the interaction, the target information including a list of target items, wherein the recommendation information associated with the user is generated further based at least in part on the target information.

26. The method of claim 15, further comprising:
determining a list of item types associated with an item,
providing, for display to the user, the list of item types associated with the item, and
identifying, based at least in part on user input, a recommended item type from the list of item types, wherein the list of recommended items includes the item and an indication of the recommended item type associated with the item.

27. The method of claim 15, further comprising:
obtaining location information associated with the list of recommended items,
generating a path recommendation associated with the retail entity based at least in part on the location information, and
providing the path recommendation for display to the user.

28. The method of claim 15, wherein the list of recommended items is sorted based at least in part on location information associated with the user.

29. A non-transitory computer-readable medium storing a set of instructions, the set of instructions comprising:
one or more instructions that, when executed by one or more processors of a device, cause the device to:
receive intent information associated with an interaction of a user with a retail entity;
obtain a set of recommendation parameters;
generate recommendation information associated with the user, the recommendation information being generated based at least in part on the intent information and the set of recommendation parameters; and
provide the recommendation information for display to the user, the recommendation information including a list of recommended items.

30. An apparatus, comprising:
means for receiving intent information associated with an interaction of a user with a retail entity;
means for obtaining a set of recommendation parameters;
means for generating recommendation information associated with the user, the recommendation information being generated based at least in part on the intent information and the set of recommendation parameters; and
means for providing the recommendation information for display to the user, the recommendation information including a list of recommended items.
